(19) United States
(12) Patent Application Publication
(10) Pub. No.: US 2016/0118872 A1
(43) Pub. Date: Apr. 28, 2016

(54) LINEAR MOTOR

(71) Applicant: HON HAI PRECISION INDUSTRY CO., LTD., New Taipei (TW)

(72) Inventors: PO-KUANG CHEN, New Taipei (TW); CHANG-SHENG WANG, New Taipei (TW); MI-CHIEN CHEN, New Taipei (TW)

(21) Appl. No.: 14/688,797

(22) Filed: Apr. 16, 2015

(30) Foreign Application Priority Data
Oct. 22, 2014 (TW) 103136395

(51) Int. Cl. H02K 41/02; H02K 1/20

(52) U.S. Cl. CPC H02K 41/02; H02K 1/20

(57) ABSTRACT

A linear motor includes a stator and a rotor. The stator has a first plate, a second plate, and a plurality of permanent magnets mounted on the first plate and the second plate. The rotor has a main body positioned between the first plate and the second plate, a plurality of electric coils received in the main body, and one or more cover plates. The main body includes a first outer surface facing the first plate, and a second outer surface facing the second plate. A flow passage is defined in at least one of the first outer surface and the second outer surface, and at least one of the one or more cover plates is mounted on one of the first outer surface and the second outer surface covering the flow passage. Cooling fluid is flowable through the flow passage.

### FIELD

The subject matter herein generally relates to a linear motor.

### BACKGROUND

Linear motors are increasingly used in semiconductor manufacturing process and automation process. A conventional linear motor includes a coil part and a magnet yoke part. A plurality of coils are arranged in a single line in the coil part. A plurality of permanent magnets are arranged in a single line state so as to face the coil line in the magnet yoke part. The coil part is energized so that an electromagnetic force is generated and a thrust force (driving force) is generated to the permanent magnet. If temperature is increased due to heat from the coil, the resistance of the coil itself is increased resulting in a driving current is reduced. In the linear motor, since the thrust force is proportional to the driving current, the thrust force is decreased as the driving current is decreased.

### BRIEF DESCRIPTION OF THE DRAWINGS

Implementations of the present technology will now be described, by way of example only, with reference to the attached figures.

FIG. 1 is an isometric view of one embodiment of a linear motor.

FIG. 2 is a diagrammatic side view of a stator of the linear motor in FIG. 1.

FIG. 3 is an exploded isometric view of a rotor of the linear motor in FIG. 1.

FIG. 4 is an isometric view of a main body of the rotor of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “outside” refers to a region that is beyond the outermost confines of a physical object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a linear motor.

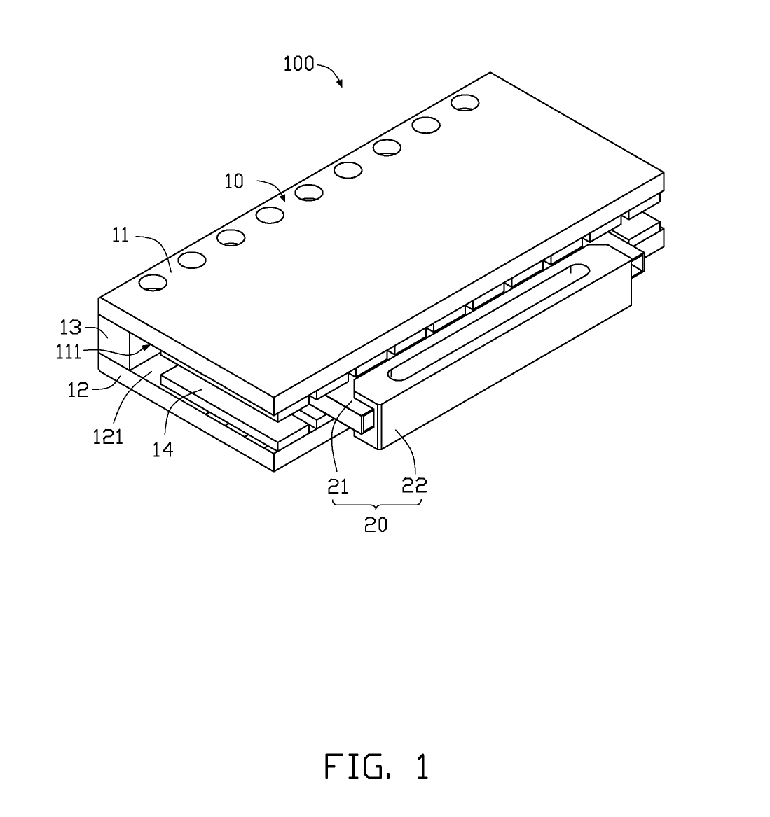

FIG. 1 illustrates that a linear motor 100 can include a stator 10 and a rotor 20. The stator 10 can include a first plate 11, a second plate 12, a spacing block 13 sandwiched between the first plate 11 and the second plate 12, and a plurality of permanent magnets 14. The second plate 12 can be positioned opposite and substantially parallel to the first plate 11. The first plate 11 and the second plate 12 can be substantially rectangular plates. The first plate 11 can have a first inner surface 111 opposite, and substantially parallel to, a second inner surface 121 of the second plate 12. The spacing block 13 can be substantially strip shaped and positioned at same sides of the first plate 11 and the second plate 12. The plurality of the permanent magnets 14 can be spaced from each other and mounted on the first inner surface 111 and the second inner surface 121.

The rotor 20 can include a main body 21 and an assembly block 22. The assembly block 22 can be substantially strip shaped and positioned outside of the stator 10. One end of the main body 21 can be mounted in the assembly block 22, and other part of the main body 21 can be positioned between the first plate 11 and the second plate 12. The main body 21 can move along a direction parallel to the spacing block 13 relative to the stator 10.

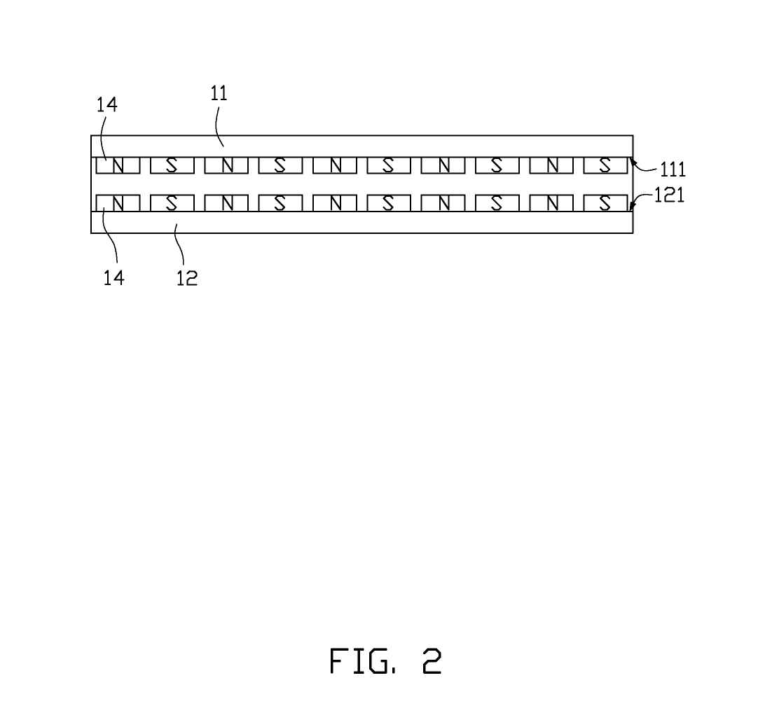

FIG. 2 illustrates the plurality of permanent magnets 14 can be arranged evenly spaced on the first inner surface 111 and the second inner surface 121. The polarities of the permanent magnets 14 on the first plate 11 and the second plate 12 are alternative. The polarities of the opposing permanent magnets 14 on the first plate 11 and the second plate 12 are same. The permanent magnets 14 can form a magnetic field.

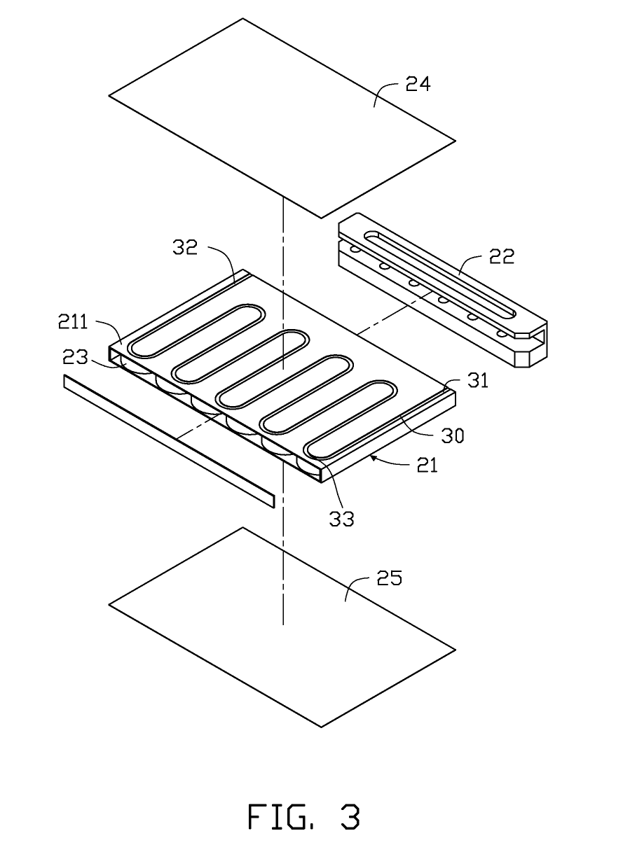

FIG. 3 illustrates that the rotor 20 can further include a plurality of electric coils 23 arranged in the main body 21, and a first cover plate 24 and a second cover plate 25 mounted on the main body 21. The electric coils 23 can resist against the main body 21 and be shaped by the main body 21. When the electric coils 23 are switched on, the electric coils 23 can generate magnetic field, and a driving force is generated to the rotor 20.

The main body 21 can include a first outer surface 211 facing the first inner surface 111, and the first outer surface 211 can define a first flow passage 30 for a cooling fluid. The cooling fluid is flowable through the flow passage 30. The heat generated by the electric coils 23 can be dissipated by the cooling fluid when the cooling fluid is passed through. The cooling fluid can be a gas or a liquid. Water with high cooling efficiency and high specific heat and the like may be used as the cooling fluid. In at least one embodiment, the first flow passage 30 can be a groove defined on the first outer surface 211, and partially cover the coils 23.

The first flow passage 30 can include an first inlet 31, an first outlet 32, and a plurality of first bending portions 33 positioned between the inlet 31 and the outlet 32. The first inlet 31 and the first outlet 32 can be arranged at two opposing sides of the first outer surface 311. In at least one embodiment, the first inlet 31 and the first outlet 32 can be arranged adjacent to the assembly block 22. In other embodiments, the first inlet 31 and the first outlet 32 can be arranged adjacent to the spacing block 13. Each of the bending portions 33 can be substantially U shaped, and a length of the bending portion 33 can be substantially equal to a length of a bending portion (not labeled) of the electric coil 23.

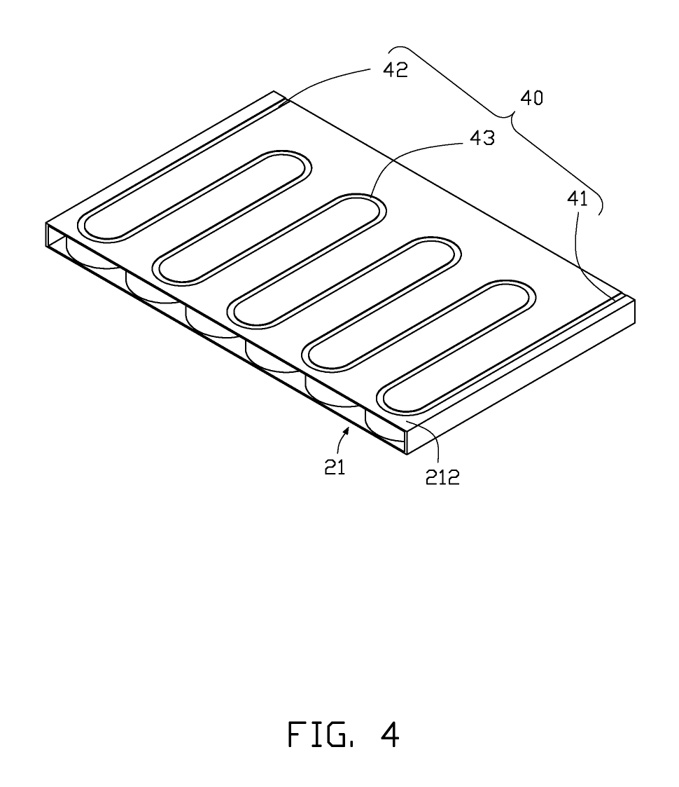

FIG. 4 illustrates that the main body 21 can further include a second outer surface 212. The second outer surface 212 can face the second inner surface 121. The second outer surface 212 can be opposite, and substantially parallel to, the first outer surface 211. The second outer surface 212 can include a second flow passage 40, which including an second inlet 41, an second outlet 42, and a plurality of second bending portions 43 positioned between the second inlet 41 and the second outlet 42. FIG. 3 and FIG. 4 illustrate that the second outer surface 212 can be opposite to the first outer surface 211. The first cover plate 24 can be used to cover the first flow passage 30, and the second cover plate 25 can be used to cover the second flow passage 40.

In assembling, the first plate 11 and the second plate 12 can be connected to the spacing block 13, and the permanent magnets 14 can be mounted to the inner surfaces of the first plate 11 and the second plate 12. The electric coils 23 can be arranged in a line and deposited into a molding (not shown). Then, the main body 21 can be formed in the molding by insert molding method, and the electric coils 23 can be received in and shaped by the main body 21. At the same time, the first flow passage 30 and the second flow passage 40 can be formed in the first outer surface 211 and the second outer surface 212. The two cover plates 24 can be mounted to the first outer surface 211 and the second outer surface 212, and then one end of the main body 21 and the two cover plates 24 can be fixed in the assembly block 22, and the other end of the main body 21 and the two cover plates 24 can be assembled in the stator 10. In at least one embodiment, the main body 21 can be made of epoxy resin. The molding can define grooves corresponding to the flow passages, such that the flow passages 30 can be formed with the main body 21.

In use, the rotor 20 can move relative to the stator 10, and the electric coils 23 can generate heat. The cooling fluid can flow in the first flow passage 30 and the second flow passage 40. As the cooling fluid can contact the main body 21, the electric coils 23 can be cooled, and the heat dispassion effect of the linear motor 100 can be increased.

In other embodiments, the first plate 11 and the second plate 12 of stator 10 can be substantially column shaped, and the main body 21 can be substantially column shaped. The main body 21 can include only one surface toward the first plate 11 and the second plate 12, and cover plate 24 can be one.

The first plate 11, the second plate 12, and the spacing block 13 can be connected by screws. In other embodiments, the first plate 11, the second plate 12, and the spacing block 13 can be integrally formed.

In other embodiments, the second flow passage 30 on the second outer surface 212 of the rotor 20 can be omitted. The first flow passage 30 can be other shape. The bending portion 33 can be one, and the first flow passage 30 can be more than one.

In other embodiments, the first cover plate 24 can cover a part of the first outer surface 211 to cover the first flow passage 30, and the second cover plate 25 can cover a part of the second outer surface 212 to cover the second flow passage 40.

The linear motor can define flow passages on the surfaces of the main body, the volume of the linear motor would not increased. The flow passage can be defined adjacent to the electric coils, and the linear motor can get a good heat dissipation effect. The thrust force of the linear motor would not decreased, and the linear motor can be more stable. Furthermore, when the rotor is cooled, the location accuracy of the linear motor can be improved, and the use life of the linear motor can be increased.

The embodiments shown and described above are only examples. Many details are often found in the art such as the other features of a linear motor. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A linear electric motor comprising:
a stator having:
a first plate;
a second plate positioned opposite and substantially parallel to the first plate;
a plurality of permanent magnets;
wherein, the first plate has a first inner surface opposite, and substantially parallel to, a second inner surface of the second plate;
wherein, the first plate and the second plate are positioned to define a space between the first inner surface and the second inner surface; and
wherein, the plurality of permanent magnets are mounted on the first inner surface and the second inner surface;
a rotor having:
a main body positioned between the first stator plate and the second stator plate, the main body having a first outer surface and a second outer surface opposite, and substantially parallel to, the first outer surface, with the first main body outer surface facing the first stator plate inner surface and the second main body surface facing the second stator plate inner surface;
a plurality of electric coils positioned in the main body;
one or more cover plates;
wherein, a flow passage is defined in at least one of the first main body outer surface and the second main body outer surface;
wherein, at least one of the one or more cover plates is mounted on one of the first main body outer surface and the second main body surface covering the defined flow passage; and
wherein, cooling fluid is flowable through the flow passage.

2. The linear motor as claimed in claim 1, wherein the first plate and the second plate are substantially rectangular plates.

3. The linear motor as claimed in claim 1, wherein the first plate, the second plate, and the main body are substantially column shaped.

4. The linear motor as claimed in claim 1,
wherein the flow passage is a groove extending on the first outer surface and the second outer surface, and partially covered the electric coils; and
wherein the flow passage includes a first flow passage defined in the first outer surface, and a second flow passage defined in the second outer surface.

5. The linear motor as claimed in claim 4, wherein the first flow passage includes an first inlet, an first outlet, and at least one first bending portion positioned between the first inlet and the first outlet; the second flow passage includes an second inlet, an second outlet, and at least one second bending portion positioned between the second inlet and the second outlet.

6. The linear motor as claimed in claim 5, wherein the first inlet and the first outlet are arranged at two opposing sides of the first outer surface; the second inlet and the second outlet are arranged at two opposing sides of the second outer surface.

7. The linear motor as claimed in claim 1, wherein the rotor further includes an assembly block positioned outside of the stator and connected to one end of the main body.

8. The linear motor as claimed in claim 1, wherein the main body is made of epoxy resin, and the flow passage is integrally formed with the main body.

9. The linear motor as claimed in claim 1, wherein the one or more cover plates is a shin sheet.

10. The linear motor as claimed in claim 1, wherein the stator further includes a spacing block connected between the first plate and the second plate; the polarities of the permanent magnets are alternative, and the polarities of the opposing permanent magnets mounted on the first inner surface and the second inner surface are same.
